(19) United States
(12) Patent Application Publication
(10) Pub. No.: US 2020/0401908 A1
(43) Pub. Date: Dec. 24, 2020

(54) CURATED DATA PLATFORM

(71) Applicant: Samsung Electronics Company, Ltd., Suwon Si (KR)

(72) Inventors: Andres Ortega, San Jose, CA (US); Ashwin Chandra, Santa Clara, CA (US); David Ho Suk Chung, Rancho Palos Verdes, CA (US)

(21) Appl. No.: 16/809,196

(22) Filed: Mar. 4, 2020

Related U.S. Application Data
(60) Provisional application No. 62/863,825, filed on Jun. 19, 2019.

(51) Int. Cl. G06N 5/02; G06N 20/00; G06K 9/62

(52) U.S. Cl. CPC G06N 5/02; G06K 9/6261; G06K 9/6218; G06N 20/00

(57) ABSTRACT

A method includes generating one or more graphs representing automatic content recognition (ACR) data associated with a computing device; identifying one or more paths representing at least a portion of the one or more graphs; training one or more models based on inputting the one or more paths into one or more machine-learning algorithms; producing one or more embeddings from the one or more models; and clustering the one or more embeddings to provide at least one cluster corresponding to a behavioral profile associated with the computing device.

### PRIORITY

This application claims the benefit, under 35 U.S.C. § 119(e), of U.S. Provisional Patent Application No. 62/863,825, filed on 19 Jun. 2019, which is incorporated herein by reference.

### TECHNICAL FIELD

This disclosure relates generally to generating context-aware recommendations.

### BACKGROUND

Accurately identifying a given user of communal devices used concurrently by multiple users (e.g., a television) or shared by multiple users at different times (e.g., a household personal computer) at any given time is difficult. This difficulty may have several causes, such as for example, a possible reluctance of the user to sign in or various challenges that accompany particular user identification methods like facial recognition or voice identification. Content recommendation approaches are generally based on trends per geolocation, timeslot (time-band), or day of the week. Since conventional content recommendation systems are generally unable to distinguish between individual users of a communal device, an individual user's preferences may not be adequately captured.

### BRIEF DESCRIPTION OF THE DRAWINGS

FIG. 1 illustrates an example knowledge-graph recommendation system.

FIG. 2 illustrates an example sliding window for partitioning automatic content recognition (ACR) logs.

FIG. 3 illustrates an example knowledge graph.

FIG. 4 illustrates an example random walk of a portion of a knowledge graph.

FIGS. 5-6 illustrate an example node embedding of a time-band sub-graph

FIG. 7 illustrates an example embedding clustering.

FIG. 8 illustrates an example querying of the user knowledge graph.

FIG. 9 illustrates an example method for generating recommendations of media content.

FIG. 10 illustrates an example computer system.

### DESCRIPTION OF EXAMPLE EMBODIMENTS

Embodiments described herein relate to a knowledge-graph recommendation system for generating recommendations of media content based on personalized user contexts and personalized user viewing preferences. Rather than requiring identification of the particular users of a communal or shared device, the embodiments described below identify or classify the current user behavior generating the behavior captured by a set of user activity logs (e.g., automatic content recognition (ACR) events). As example and not by way of limitation, the knowledge-graph recommendation system may generate a prediction of media content that may be of interest to users of communal devices based on observed particular user viewing preferences, such as for example, for a television (TV) program of a particular genre, airing or “dropping” on or about a particular day, and at or about a particular time-band. As described below, knowledge graphs represent a range of user facts, items, and their relations. The interpretation of such knowledge may enable the employment of user behavioral information in prediction tasks, content recommendation, and persona modeling.

The knowledge-graph recommendation system is a personalized and context-aware (e.g., time- and location-aware) collaborative recommendation system. In particular embodiments, the knowledge-graph recommendation system provides personalized experiences to communal device users that convey relevant content, increase user engagement, and reduce the time to entertainment, which can be achieved by understanding, but not necessarily identifying, the people using the communal device. At times, accurately identifying the user behind the screen presents several challenges due to the possible reluctance of the user to log into an account and/or a lack of availability for user identification (e.g., facial recognition and/or voice identification can be lacking).

In particular embodiments, the knowledge-graph recommendation system includes a pipeline to aggregate events and metadata stored in one or more activity (ACR) logs and to build a graph schema (e.g., a user knowledge graph) to optimally search through this content. In particular embodiments the knowledge-graph recommendation system may apply machine learning (ML) to the graph to train an ML model to describe the behavior of the users and predicts the best program recommendation given the user's contextual information, such as geolocation, time of the query, and/or user preferences, etc. Further, in particular embodiments the knowledge-graph recommendation system provides highly personalized content recommendations that capture community collaborative recommendations as well as content metadata recommendations.

While the present embodiments may be discussed primarily with respect to television-content recommendation systems, it should be appreciated that the present techniques may be applied to any of a number of recommendation systems that may facilitate users in discovering particular items of interest (e.g., movies, TV series, documentaries, news programs, sporting telecasts, gameshows, video logs, video clips, etc. that the user may be interested in consuming; particular articles of clothing, shoes, fashion accessories, or other e-commerce items the user may be interested in purchasing; certain podcasts, audiobooks, or radio shows to which the particular user may be interested in listening; particular books, e-books, or e-articles the user may be interested in reading; certain restaurants, bars, concerts, hotels, groceries, or boutiques in which the particular user may be interested in patronizing; certain social media users in which the user may be interested in “friending”, or certain social media influencers or content creators in which the particular user may be interested in “following”; particular video-sharing platform publisher channels to which the particular user may be interested in subscribing; certain mobile applications (“apps”) the particular user may be interested in downloading; and so forth) at a particular instance in time.

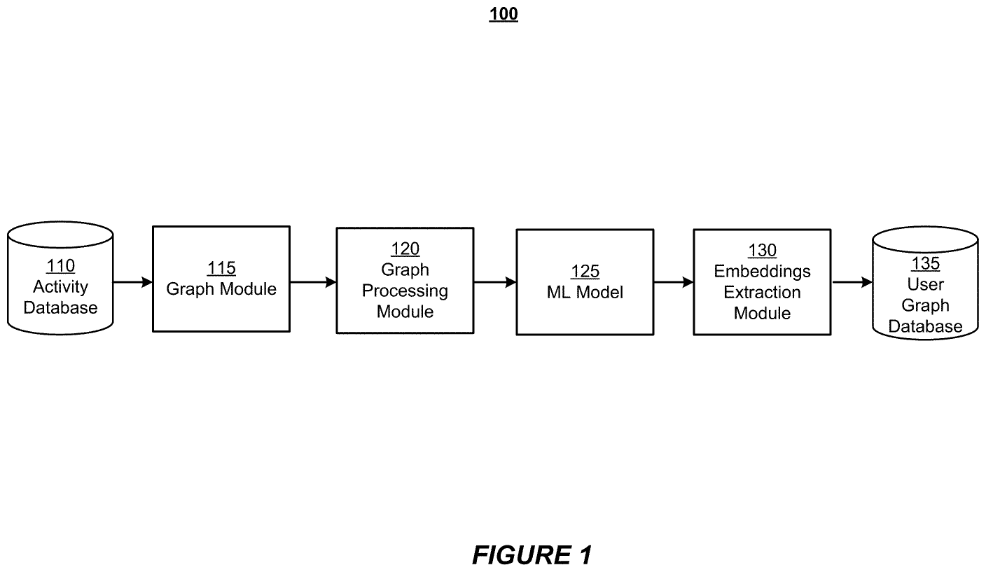

FIG. 1 illustrates an example knowledge-graph recommendation system. As illustrated in the example of FIG. 1, the knowledge-graph recommendation system 100 may include one or more activity (ACR) databases 110, graph modules 115, graph processing modules 120, ML models 125, embeddings extraction modules 130, and user graph database 135. In certain embodiments, the knowledge-graph recommendation system 100 may include a cloud-based cluster computing architecture or other similar computing architecture that may receive one or more ACR observed user viewing inputs 110 and provide TV programming data or recommendations data to one or more client devices (e.g., a TV, a standalone monitor, a desktop computer, a laptop computer, a tablet computer, a mobile phone, a wearable electronic device, a voice-controlled personal assistant device, an automotive display, a gaming system, an appliance, or other similar multimedia electronic device) suitable for displaying media content and/or playing back media content. ACR is an identification technology that recognizes content played on a media device or is present in a media file. Devices containing ACR support enable users to quickly obtain additional information about the content being viewed without any user-based input or search efforts. In particular embodiments, knowledge-graph recommendation system 100 may be utilized to process and manage various analytics and/or data intelligence such as TV programming analytics, web analytics, user profile data, user payment data, user privacy preferences, and so forth. For example, in one embodiment, knowledge-graph recommendation system 100 may include a Platform as a Service (PaaS) architecture, a Software as a Service (SaaS) architecture, and an Infrastructure as a Service (IaaS), or other various cloud-based cluster computing architectures.

Activity database 110 may store ACR data that includes recorded events containing an identification of the recently viewed media content (e.g., TV programs), the type of event, metadata associated with the recently viewed media content (e.g., TV programs), and the particular day and hour (e.g., starting-time timestamp or ending-time timestamp) the recently viewed media content (e.g., TV programs) was viewed. In particular embodiments, activity database 110 may further include user profile data, programming genre data, programming category data, programming clustering category group data, or other TV programming data or metadata. As an example and not by way of limitation, the ACR events stored in activity database 110 may include information about the program title, program type, program cast, program director as well as device geolocation, device model, device manufacturing year, cable operator, or internet operator. In particular embodiments, the time-band information also be enriched by other external sources of information that are not necessarily part of the ACR logs like census demographic information or statistics from data collection and measurement firms.

In particular embodiments, the ACR events may be expressed by content that is consumed (e.g., presented to a viewer) during a set of time-bands (e.g., 7 time-bands/day). This may be especially appropriate for broadcast programming where “dayparting” is the practice of dividing the broadcast day into several parts and in which different types of radio or television program typical for that time-band is aired. For example, television programs may be geared toward a particular demographic and what the target audience typically consumes at that time-band. Herein reference to a time-band may encompass the information associated with a part of a day and a day of the week, where appropriate. In particular embodiments, the maximum number of time-bands per device is 7 days in a week and 7 time-bands per day for a total of 49 time-bands. As an example and not by way of limitation, ACR events may denote “Monday at prime-time” as the name of a particular time-band and the information is the set of ACR logs recorded during that time-band.

In particular embodiments, graph module 115 may receive the ACR user observed viewing input of recently viewed by a particular user stored on activity database 110. As described in more detail, graph module 115 may transform the ACR event data stored on activity database 110 to a knowledge graph that represents the relations between concepts, data, events, and entities. In particular embodiments, graph processing module 120 may access the knowledge graph generated by graph module 115 to partition and process the knowledge graph into subgraphs and for use in training ML model 125. In particular embodiments, ML model 125 is configured to generate data (e.g., embeddings vector(s)) to represent all the entities present in the ACR logs (e.g., devices, programs, metadata, or location) stored on activity database 110 into an embedding space (e.g. n-dimensional Euclidean space), as described in more detail below. Embeddings extraction module 130 may take the output of ML model 125 and determine a representation of the behavior of devices across the entire knowledge graph. The representation of the behavior of devices from embeddings extraction module 130 may be stored in user graph database 135.

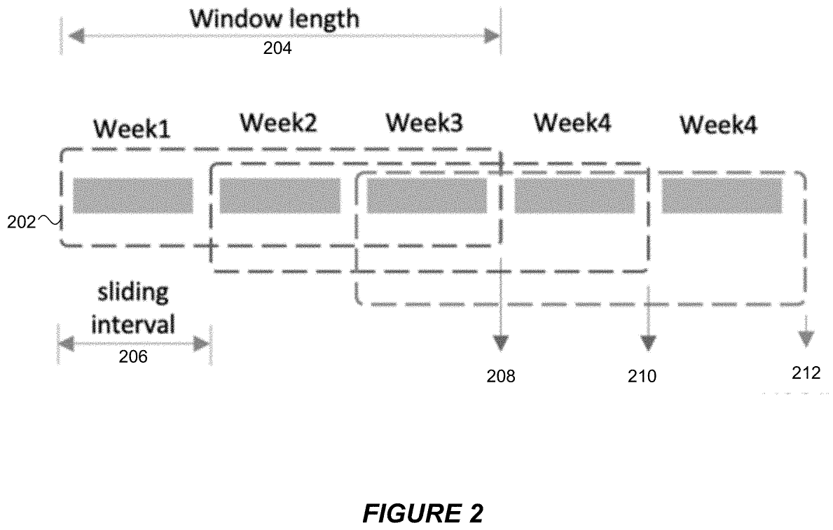

FIG. 2 illustrates an example sliding window for partitioning ACR logs. In particular embodiments, instead of using the entire set of ACR data stored in the activity database, a subset of items representing the most recent ACR data may be provided to the graph module, described above. This may be accomplished through the use of a sliding window 202 to partition the ACR logs stored on the activity database. In particular embodiments, the sliding window may be configured based on two parameters. The first parameter is a window length 204 which limits the amount of ACR data to be provided to the graph module, and the second parameter is a sliding interval 206 which is a time offset between consecutive aggregations. As illustrated in the example of FIG. 2, window length 204 may have a time interval of three weeks and sliding interval 206 is an offset of one week. This results in a first aggregation of ACR data 208 that is computed at the end of the third week after which a new aggregation of ACR data 210 and 212 is computed every subsequent week and each data aggregation includes the most recent three weeks of ACR data.

The use of sliding window 202 addresses two different issues. First, user behavior may change over time, and second, there may be insufficient ACR data associated with a particular time-band for the ML model to properly infer a pattern to best describe behavior associated with a particular communal device. As an example and not by way of limitation, if the data analysis is performed using the entire historical data, an introduction of noise to the dataset may result and the data analysis may consider behavioral patterns that might no longer be relevant to the users. As another example, the set of ACR events associated with a particular time-band is a signal that may be used to infer the preferences of users of a communal device and the strength of this signal may depend on the number of events and the duration of the events. If the data analysis only accounts for a relatively small sample (e.g., one week of ACR events), training the ML model may produce results that are unreliable or that inaccurately models the behavior associated with the communal device.

The resolution or granularity of the ACR data aggregation (e.g., 208) may depend on the aspects of the behavior of the communal device that should be considered. As an example and not by way of limitation, for TV content consumption behavior, the data provided to the graph module may include ACR data aggregations (e.g., 208) for programs and metadata for genre, cast and director and program type, where the ACR data will be grouped for all the available time-bands the communal device was active.

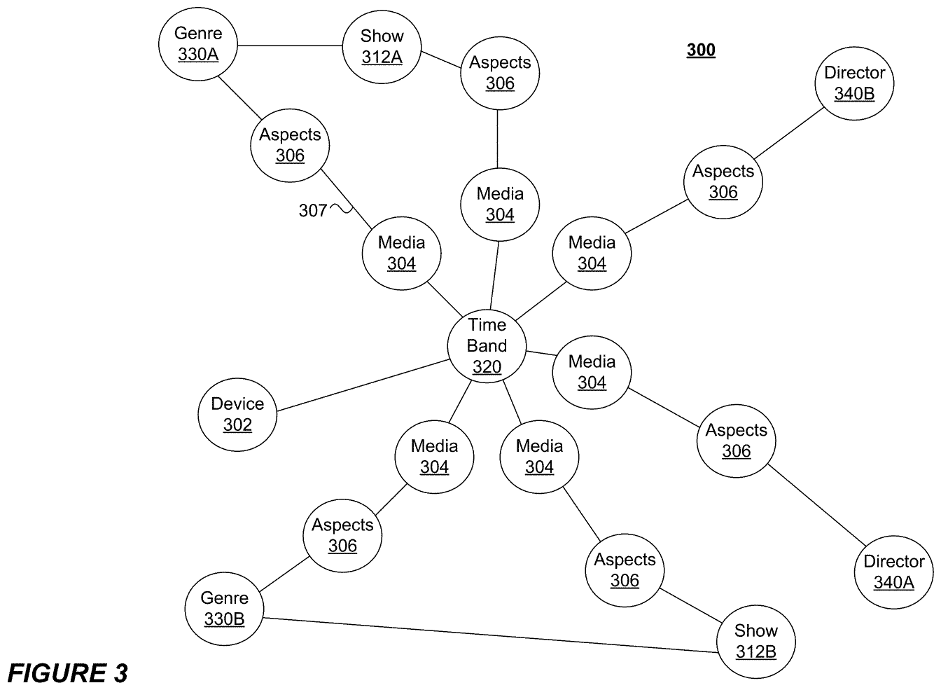

FIG. 3 illustrates an example knowledge graph. A knowledge graph 300 is a database stored as a graph that represents facts about the world in the form of an ontology (or object model) of categories, properties and relations between concepts, data, events, and entities. Knowledge graph 300 is graph structure composed of nodes (e.g., 304) and edges 307 between nodes. Nodes (e.g., 304) of knowledge graph 300 represent types of entities and the edges 307 represent the relationship between connected nodes (e.g., 304 and 306). In particular embodiments, knowledge graph 300 may be heterogeneous, where nodes (e.g., 302 and 304) might be of different types. The nodes of knowledge graph 300 may include one or more device nodes 302 that correspond to the devices whose activity generates the activity (ACR) logs. Knowledge graph 300 may further include media nodes 304 that correspond to particular types of media correspond to types of media content. As an example and not by way of limitation, media nodes 304 may correspond to movies, TV series, documentaries, news programs, sporting telecasts, game shows, video logs, or video clips. In particular embodiments, knowledge graph 300 may further include a time-band node 320 that corresponds to a particular time-band, described above, that represents a particular period of time of a particular day of the week.

In particular embodiments, knowledge graph 300 may include aspect nodes 306 that may indicate different aspects or characteristics of particular media content. As an example and not by way of limitation, aspect nodes 306 for TV content may index aspects, such for as example, if the aspect is a program, program type, genre, cast members, or director. As another example, aspect nodes 306 for video or computer games may index aspects, such for as example, if the aspect is a game title, game genre, or game console. As another example, aspect nodes 306 for applications (“apps”) may index aspects, such for as example, if the aspect is an app type or app category. In particular embodiments, knowledge graph 300 may include nodes that index particular aspects associated with aspect nodes 306. As an example and not by way of limitation, aspect nodes 306 may correspond to a program may be connected to a show node 312A or 312B indicating a particular program (e.g., Drama Show X). As another example, aspect nodes 306 may correspond to a genre may be connected to a show node 330A or 330B indicating a particular genre (e.g., comedy). As another example, aspect nodes 306 may correspond to a director may be connected to a director node 340A or 340B indicating a particular director.

Edges 307 may be weighted with an associated value that quantifies the affinity between the two nodes it connects (e.g., show node 312A and genre node 330A). In particular embodiments, the weighting or affinity between nodes may be a function of the total duration the user was engaged with the corresponding content (e.g., media node 304). The weight of edge 307 may define how much influence the relationship between nodes has in the process of modeling the consumption behavior of a communal device. In particular embodiments, the relationship (edges 307) between nodes (e.g., 312A and 330A) may be treated as unidirectional because for practical purposes they are reciprocal. For example “programs” (e.g., show node 312A) that “belongs to” a “genre” (e.g., genre node 330A) may also be expressed as a “genre” (e.g., genre node 330A) that “groups/owns” many “programs” (e.g., show node 312A).

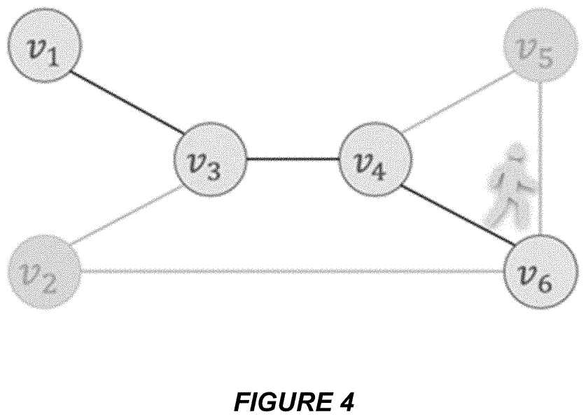

FIG. 4 illustrates an example random walk of a portion of a knowledge graph. In particular embodiments, the ML model may be defined and limited to specific portions of the knowledge graph that are determined based on meta-paths of the knowledge graph. In particular embodiments, one or more meta-paths of the knowledge graph may be determined using random walk techniques. A random walk is a sequence of nodes v₁, v₂, . . . vₖ where two adjacent nodes (e.g., v₁ and v₃) in the random walk are connected by an edge and the length of a random walk is defined by the number of edges in the path. A random walk may be generated by a stochastic process that starts at a node (e.g., v₃) and randomly jumps to any of the connected nodes (e.g., v₁ or v₂). As illustrated in the example of FIG. 4, a three-step random walk or meta-path may include nodes v₁, v₃, v₄, and v₆, and includes three edges connecting node v₁ to node v₃, node v₃ to node v₄, and node v₄ to node v₆.

In particular embodiments, one or more meta-paths may be determined using a uniform random walk technique. The uniform random walk technique has a probability of traversing from a first node (e.g., v₃) to jump from a second connected node (e.g., v₄) that is equal for any other connected node (e.g., v₂). In other words, it is equally probable that the uniform random walk would travel from node v₃ to node v₄ or node v₂. In particular embodiments, one or more meta-paths may be determined using a weighted random walk technique. The weighted random walk has a probability of traversing from a first node (e.g., v₃) to a second connected node (e.g., v₄) that depends on the weight of the edge connecting the first node (e.g., v₃) to the second node (e.g., v₄). As an example and not by way of limitation, if the weight of the edge connecting node v₃ to node v₄ is higher than the weight of the edge connecting node v₂ to node v₄, then the meta-path is more likely to traverse from node v₃ to node v₄ than from node v₂ to node v₄. In particular embodiments, the weight of the edge connecting the nodes may be a function of the total duration the user was engaged with the corresponding media. In particular embodiments, the probability of traversing a particular step from a particular node may be proportional to the weight of the particular step divided by the sum of weights of all possible steps from that node.

In particular embodiments, one or more meta-paths may be determined using a guided or meta-path random walk technique. In other words, the meta-paths provide a blueprint of how to produce a random walk. The technique guided random walk is tailored for heterogeneous graphs where the knowledge graph includes different types of nodes (e.g., day, time-band, program type, program, or director for TV content). In particular embodiments, the traversed path may be guided by a semantic sub-graph that contains the conceptual structure of the graph (namely the relations between the different types of nodes). In other words, the random walk may traverse a node (e.g., v₃) to a connected node (e.g., v₄) based on a constraint of choosing a specific type of node in the next step of the walk. The sequence of the types of nodes may be based on the conceptual structure of the semantic sub-graph.

The ML model, described above, may be a two-layer neural network that attempts to model all the entities present in the ACR logs (e.g., devices, programs, metadata, location, etc.) into an embedding space, described below. In particular embodiments, ML may be applied on top of the knowledge graph or a portion of the knowledge to train an ML model that describes the consumption behavior of a communal device and predicts the next best-match program recommendation given contextual information like geolocation, time of the query, or user preferences. Training the ML model may be performed using the consolidated set of random walks which is the result of following a meta-path during the production of random walks. In particular embodiments, the ML model is trained by providing a context the ML model predicts is the most likely node that belongs to that context or by predicting the context based given a node. A context may be defined as nodes that are adjacent to a given node for a given meta-path. As an example and not by way of limitation, for the example of FIG. 4, the ML model may be trained to predict the context of nodes v₃ and v₆ if node v₄ is provided as an input. As another example, the ML model may be trained to predict node v₃ if node v₄ and v₁ is provided as a context input. The ML model, illustrated in the example of FIG. 1, may receive as an input the set of random walks, described above, where each node will be the starting node for several random walks of length k, to produce the embedding vector for each node in the knowledge graph. All of the nodes that were traversed during at least one of the random walks, described above, has an associated embedding vector. Embedding vectors are positioned in an embedding space such that nodes that share common contexts in the embedding space are located in proximity to one another.

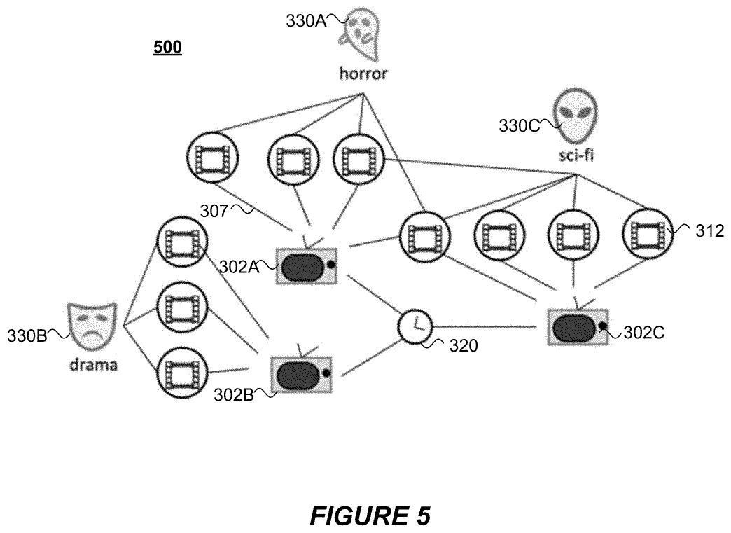

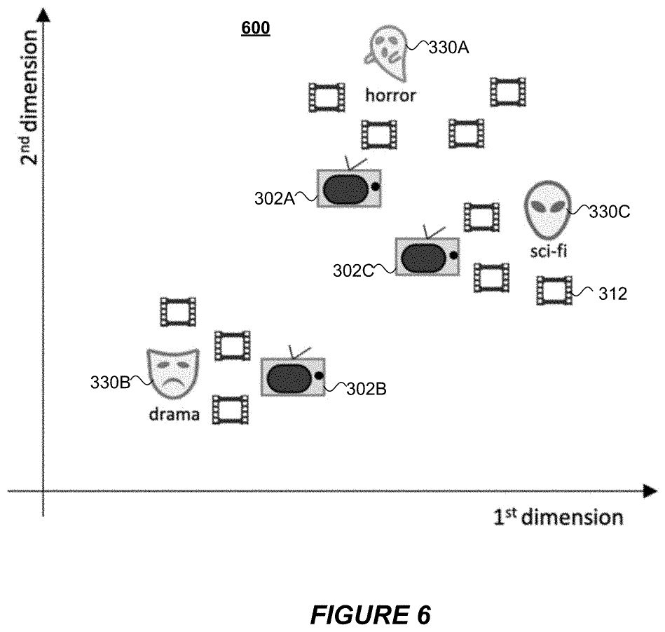

FIGS. 5-6 illustrate an example node embedding of a time-band sub-graph.

Node embedding of the knowledge graph represents both the topology and semantics of the knowledge graph for all the concepts and relations in the knowledge graph while keeping track of the original context. Node embedding transforms nodes, edges, and their features from the higher dimensional time-band sub-graph 500 illustrated in the example of FIG. 5 into vector space (a lower-dimensional space, a.k.a. embedding space) preserving both the structural and the semantical information of the sub-graph 500 into an embedding space 600, as illustrated in the example of FIG. 6. As described above, knowledge graph 500 may include device nodes 302A-C, time-band node 320, genre nodes 330A-330C, and show nodes 312 that are connected by edges 307. In particular embodiments, the embeddings extraction module, described above, may transform time-band sub-graph 500, illustrated in the example of FIG. 1, to a 2-dimensional embeddings space 600, illustrated in the example of FIG. 6. The location of each node (e.g., 312) in the embedding space 600 may be described by a pair of coordinates (d₁, d₂) where in general dₙ is n^{th}-dimension in embedding space 600. In particular embodiments, the node embedding transformation performed by the embedding extraction module produces embedding space 600 with relative positions between nodes (e.g., 312 and 330C) so that the distance between nodes (e.g., 312 and 330C) is a measure of how similar the nodes are.

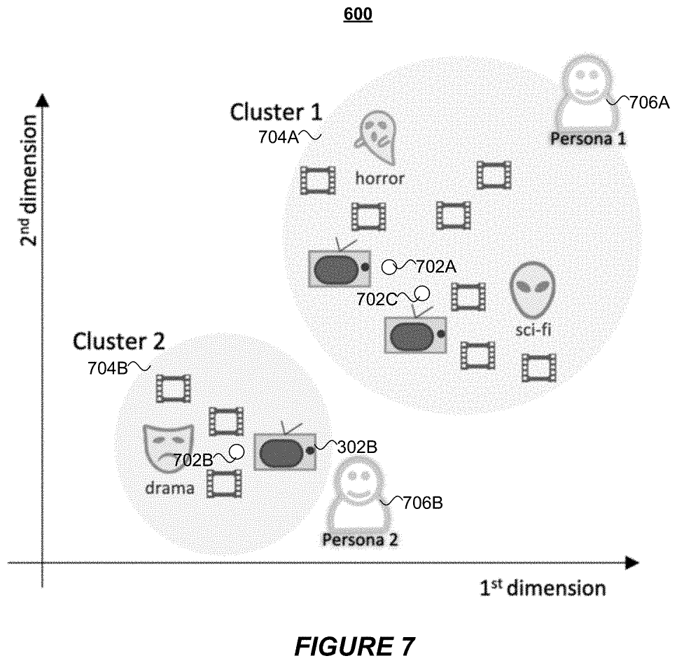

FIG. 7 illustrates an example embedding clustering. In particular embodiments, the embedding extraction module may reduce the embedding vectors for the set of device nodes 302A-302C present in embedding space 600 into single embedding vector or embedding by computing a weighted average of the embedding vectors generated by the ML model. In particular embodiments, the weighted average may be calculated as a “center of mass” of the embeddings, such as using equation (1):

$${E}_{m} = \frac{{w}_{1} {E}_{1} + {w}_{2} {E}_{2} + … {w}_{{nE}_{n}}}{{w}_{1} + {w}_{2} + … + {w}_{n}} \qquad ( 1 )$$

where Eₘ is the embedding of device's time-band information 702A-702C, wₓ is the weight of the x^{th} aspect nodes (e.g., 330A-330C, and 312), Eₓ is the embedding vector of the x^{th} aspect nodes (e.g., 330A-330C, and 312) and n is the number of nodes (e.g., 330A-330C, and 312) in embedding space 600. In particular embodiments, the value wₓ is a function of the distance in embedding space 600 between nodes (e.g., 312 and 330C). For unweighted graphs, where wₓ has a value of 1, centers of mass 702A-702C from equation (1) are equal to the average value of the embedding vectors Eₓ.

Embeddings or centers of mass 702A-702C for all time-bands logged across all device nodes 302A-302C may be used to identify patterns of user behavior. In particular embodiments, the user behavior may be identified by globally clustering embeddings or centers of mass 702A-702C of time-band embedding space 600 and each resulting cluster 704A-704B may be representative of the consumption behavior of one or more communal devices. In particular embodiments, each cluster 704A-704B or persona may be interpreted as identification by association, where devices (device nodes 302A-302C) having similar consumption behavior may share the same cluster 704A-704B. As an example and not by way of limitation, centers of mass 702A-702C may be clustered using any suitable clustering technique, such as for example, k-means or DBSCAN. For k-means clustering, determining a value for the number of clusters 704A-704B for the algorithm may be difficult when no previous knowledge of the data set is available. In particular embodiments, a value for the number of clusters may be estimated by visualizing the data points in 2-dimensions by using dimensional reduction and determine the number of clusters present when the data is plotted in a scatter-plot. As an example and not by way of limitation, T-distributed Stochastic Neighbor Embedding (T-SNE) may be used to perform this visualization and may be used in tandem with k-means clustering.

In particular embodiments, the devices, corresponding to device nodes 302A-302C, may be mapped to a particular persona 706A-706B that best represents the consumption behavior of a communal device for a particular time-band. As illustrated in the example of FIG. 7, there are two clusters 704A-704B for the example of time-band sub-graph 300 based on clustering centers of mass 702A and 702C, and 702B. Although cluster 704B may only include time-band consumption activity of a single device node 302B, in practice, clusters 704A and 704B may be formed by up to thousands of centers of mass 702A-702C. In particular embodiments, clusters 704A-704B defines a “persona” that represents the consumption behavior of one or more device nodes 702A-702C corresponding to a respective communal device. In other words, a “persona” is a cluster of consumption behavior represented by centers of mass 702A-702C that when agglomerated form a particular cluster. An embedding vector for personas 706A-706B may be determined based on a mean value of clusters 704A-704B (the center of clusters 704A-704B). In particular embodiments, node embedding of the consumption activity of device nodes 302A-302C may be performed to determine program embedding vectors. The program embedding vectors may be used to validate that the node embedding for program nodes 312 are agglomerated to form clusters. In principle, these clusters of program nodes 312 may ensure that programs whose similarity is derived for the community viewing behavior similar to collaborative filtering.

In particular embodiments, both the embedding and the corresponding nodes are stored in a user knowledge graph (UKG) that may contain all aspects involved in the modeling of a persona such as for example genre nodes, program nodes 312, device nodes 302A-302C, time-band embedding vectors per device, and the embedding vectors for “personas” 706A-706B and program clusters, described above.

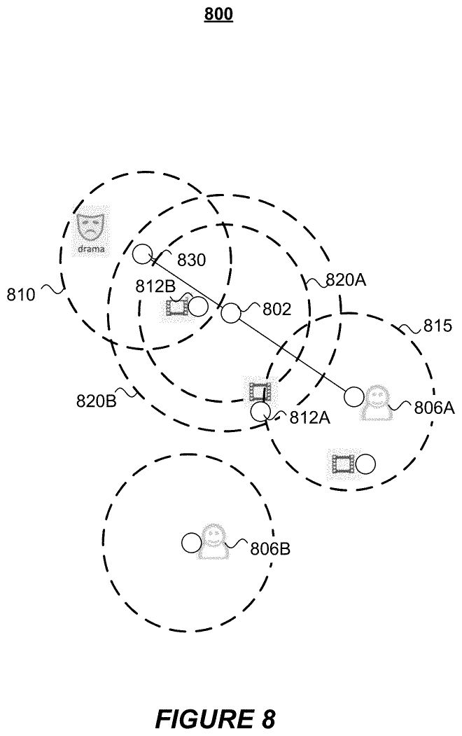

FIG. 8 illustrates an example querying of the user knowledge graph. As described above, identified user patterns may be represented as a number of “personas” 706A-706B. As an example and not by way of limitation, for a given a new media consumption activity, a “persona” 806A-806B that best matches the context (current time and location) of the consumption activity, preferences, and viewing behavior may be identified. The knowledge-graph recommendation system may produce tailored experiences and personalized recommendations for the “persona” 806A-806B representing the audience of a communal device. In particular embodiments, node embedding, described above, may enable similarity-based techniques (like clustering or nearest neighbors) to be applied in a multimodal fashion to derive insightful information that combines consumption behavior, community behavior, items, and its metadata to produce a model of what users of a communal device might like or be interested in. In particular embodiments, one or more recommendations may be generated based on the context that may include device information (e.g., based on UUID), day of the week, time-band, current program or genre, and returning the nearest neighbors to a seed 802 representing this context.

In particular embodiments, the knowledge-graph recommendation system may use a fuzzy query engine to generate personalized, context-aware recommendations. A query engine may be considered “fuzzy” since depending on where seed 802 is located in embedding space 800, different results may be obtained. Fuzzy query engines are able to mix several query terms into seed 802, thereby making it possible to trade-off the query results between relevance and personalization. The user knowledge graph embedding vectors allows the fuzzy query engine to query its data by using a seed 802 in the embedding vector space 800. In particular embodiments, seed 802 may be obtained as the result of linear operations (e.g. add, subtract, averaging, or translation) applied to one or more node embeddings. The returned set of recommendations may be extracted using the k-nearest neighbors (k-NN) to seed 802 sorted by similarity. In particular embodiments, the similarity may be computed using the Euclidean distance between seed and the nearest neighbors or by employing equivalent techniques that can operate over vectors like cosine similarity.

In particular embodiments, the knowledge-graph recommendation system may identify the “persona” 806A-806B that best represents the current context (e.g., the current day of the week and current time-band) to compose a time-band index. The knowledge-graph recommendation system may then access embedding vectors that are associated with the identified “persona” 806A-806B for that time-band from the data stored in the knowledge graph database. If more contextual information is available, the knowledge-graph recommendation system may access the embedding vectors for each of the terms in the “extended” context (e.g., genre or program embedding vectors). Once all the embedding vectors for the query terms are identified, seed 802 may be computed using the equation (1), described above, for the center of mass for node embeddings. Examples queries may take the form of:

X=embedding(persona),
where X is the seed for the query
Because you watch show Y:

X=w₁×x embedding(persona)+w₂×embedding(Y)
where wₙ is the weight for the n^{th} embedding and =1
Genre query:

X=w₁×embedding(persona)+w₂×embedding(genre)
where w₁ and w₂ are the weights, the w₁, w₂ ratio balances the query between personalization and relevance
Multi-genre query:

X=w₁×embedding(persona)+w₂×embedding(genre₁)+w₃×embedding(genre₂)
Multi-program query:

X=w₁×embedding(persona)+w₂×embedding(program₁)+w₃×embedding(program₂)

In particular embodiments, the recommendations returned by the knowledge-graph recommendation system may be a set of media content sorted in ascending order by the distance between the persona and the content in the embedding space. Alternatively, the persona's embedding retrieving the recommendations can be offset by composing a seed that mixes the embeddings the persona with the embeddings of some other entities like genre, cast, director, etc. The example of FIG. 8 illustrates the fuzzy query, a particular communal device is represented by 2 different personas 806A-806B. As an example and not by way of limitation, persona 806A may be active during the prime-time while persona 806B may be active in the early morning. For this reason, persona 806A may be identified based on the contextual information of the query (e.g., prime-time). User taste analysis may be used to infer that persona 806A may have a high affinity towards the drama genre. Seed 802 may then be computed using equation (1) using the embedding vectors for the drama genre 830 and the embedding vectors for persona 806A. In the example of FIG. 8, circle 810 encompasses the most relevant content for the “drama genre” 830 and circle 815 encompasses the most personalized media content. Returned results 812A-812B contained in circles 820A-820B may be a compromise. Instead of ranking returned results 812A-812B by relevance or closeness to drama genre 830, returned results 312A-312B may be ranked based on the distance between seed 802 and returned results 812A-812B. As an example and not by way of limitation, returned results 312A-312B may be listed in ascending order, so that returned results 312A-312B closer to seed 802 appear higher up the list.

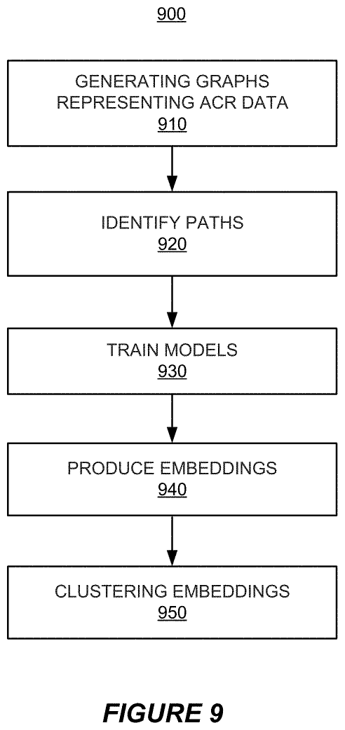

FIG. 9 illustrates an example method for generating recommendations of media content. The method 900 may begin at step 910, a computing system may generate one or more graphs representing ACR data associated with a computing device. As an example and not by way of limitation, the computing device may be a communal device, such as for example, a television or game console. At step, 920, the computing system may identify one or more paths for representing at least a portion of the graphs. In particular embodiments, the paths may be identified using a random walk technique, such as for example, a weighted random walk or a semantic-map-based random walk. At step 930, the computing system may train one or more models based on inputting the one or more paths into one or more machine-learning algorithms. At step 940, the computing system may produce one or more embeddings from the one or more models. As an example and not by way of limitation, the embedding may be produced in a time-band embedding space. At step 950, the computing system may cluster the embeddings to provide at least one cluster corresponding to a behavioral profile associated with the computing device. In particular embodiments, the clustering is performed by applying a clustering algorithm to the centers of mass of the embedding vectors of the embedding space.

Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for generating recommendations of media content including the particular steps of the method of FIG. 9, this disclosure contemplates any suitable method for generating recommendations of media content including any suitable steps. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

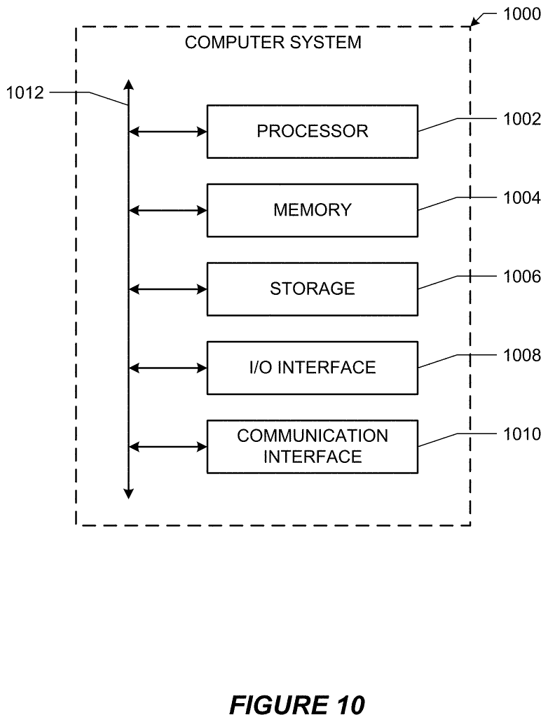

FIG. 10 illustrates an example computer system. In particular embodiments, one or more computer systems 1000 perform one or more steps of one or more methods described or illustrated herein. In particular embodiments, one or more computer systems 1000 provide the functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks.

Where appropriate, one or more computer systems 1000 may perform without substantial spatial or temporal limitation one or more steps of one or more methods described or illustrated herein. As an example, and not by way of limitation, one or more computer systems 1000 may perform in real-time or batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example, and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example, and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002.

Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example, and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere).

One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example, and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1006 for them. Where appropriate, I/O interface 1008 may include one or more device or software drivers enabling processor 1002 to drive one or more of these I/O devices. I/O interface 1008 may include one or more I/O interfaces 1006, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it.

As an example, and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example, and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The embodiments disclosed herein are only examples, and the scope of this disclosure is not limited to them. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
generating, by a computing system, one or more graphs representing automatic content recognition (ACR) data associated with a computing device;
identifying, by the computing system, one or more paths representing at least a portion of the one or more graphs;
training, by the computing system, one or more models based on inputting the one or more paths into one or more machine-learning algorithms;
producing, by the computing system, one or more embeddings from the one or more models; and
clustering, by the computing system the one or more embeddings to provide at east one cluster corresponding to a behavioral profile associated with the computing device.

2. The method of claim 1, wherein the behavioral profile includes a persona, and wherein the persona is associated with at least two users.

3. The method of claim 2, further comprising determining one or more content recommendations based on behaviors associated with the persona.

4. The method of claim 1, wherein:
the one or more graphs comprise comprises a plurality of nodes and a plurality of edges connecting the nodes; and
the plurality of nodes comprises a node corresponding to the computing device and a plurality of nodes corresponding to an aspect.

5. The method of claim 4, further comprising determining a weight for each edge in the graph.

6. The method of claim 4, wherein identifying the one or more paths comprises traversing a predetermined number of nodes connected by at least some of the plurality of edges.

7. The method of claim 6, further comprising selecting the predetermined number of nodes based on a duration that a particular content was consumed.

8. The method of claim 6, further comprising:
categorizing each of the plurality of nodes into a particular one of a plurality of concepts;
determining a relationship between the plurality of concepts; and
selecting the predetermined number of nodes based on the relationship between the plurality of concepts.

9. The method of claim 1, further comprising transforming the portion of the one or more graphs from a higher dimensional space to a lower-dimensional space.

10. The method of claim 1, further comprising determining a weighted average of the one or more embeddings, wherein clustering the embeddings comprises clustering the weighted average of the one or more embeddings with a weighted average of one or more embeddings associated with one or more other computing devices.

11. The method of claim 10, further comprising:
assigning each cluster a persona, wherein each persona is associated with one or more computing devices;
accessing, for a particular computing device, a persona with which that computing device is associated; and
generating, based on the persona and the cluster to which that persona is assigned, one or more content recommendations for presentation on the particular computing device.

12. The method of claim 1, further comprising partitioning the ACR data into one or more time-bands.

13. The method of claim 12, further comprising:
aggregating the ACR data of a particular one of the time bands over a predetermined period of time; and
reaggregating the ACR data of the particular one of the time-bands after a predetermined amount of time has elapsed.

14. A non-transitory computer-readable medium comprising instructions that, when executed by one or more processors of a computing system, cause the one or more processors to:
generate one or more graphs representing automatic content recognition (ACR) data associated with a computing device;
identify one or more paths representing at least a portion of the one or more graphs;
train one or more models based on inputting the one or more paths into one or more machine-learning algorithms;
produce one or more embeddings from the one or more models; and
cluster the one or more embeddings to provide at least one cluster corresponding to a behavioral profile associated with the computing device.

15. The medium of claim 14, wherein the behavioral profile includes a persona, and wherein the persona is associated with at least two users.

16. The medium of claim 15, further comprising instructions that when executed cause the one or more processors to determine one or more content recommendations based on behaviors associated with the persona.

17. The medium of claim 14, wherein:
the one or more graphs comprise comprises a plurality of nodes and a plurality of edges connecting the nodes; and
the plurality of nodes comprises a node corresponding to the computing device and a plurality of nodes corresponding to an aspect.

18. The medium of claim 14, further comprising instructions that when executed cause the one or more processors to determine a weighted average of the one or more embeddings, wherein the instructions that cause the one or more processors to cluster the embeddings comprise instructions that cause the one or more processors to cluster the weighted average of the one or more embeddings with a weighted average of one or more embeddings associated with one or more other computing devices.

19. The medium of claim 18, further comprising instructions that when executed cause the one or more processors to:
assign each cluster a persona, wherein each persona is associated with at one or more computing devices;
access, for a particular computing device, a persona with which that computing device is associated; and
generate, based on the persona and the cluster to which that persona is assigned, one or more content recommendations for presentation on the particular computing device.

20. A system comprising:
one or more non-transitory computer-readable storage media including instructions; and
one or more processors coupled to the storage media, the one or more processors configured to execute the instructions to:
generate one or more graphs representing automatic content recognition (ACR) data associated with a computing device;
identify one or more paths representing at least a portion of the one or more graphs;
train one or more models based on inputting the one or more paths into one or more machine-learning algorithms;
produce one or more embeddings from the one or more models; and
cluster the one or more embeddings to provide at least one cluster corresponding to a behavioral profile associated with the computing device.
